(19) United States
(12) Patent Application Publication
(10) Pub. No.: US 2009/0265487 A1
(43) Pub. Date: Oct. 22, 2009

(54) Method and System For Synchronization Indicator Enabled Sharing

(75) Inventors: Xuan Zhang, San Jose, CA (US); Jinyu Yang, Fremont, CA (US); Shi Yan, Fremont, CA (US); Lei Mei, Hangzhou (CN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: TechBridge, Inc.

(21) Appl. No.: 12/424,961

(22) Filed: Apr. 16, 2009

Related U.S. Application Data
(60) Provisional application No. 61/045,543, filed on Apr. 16, 2008.

(51) Int. Cl. G06F 1/12

(52) U.S. Cl. 710/61

(57) ABSTRACT

A method and system for synchronization indicator enabled online meetings are disclosed. According to one embodiment, a computer implemented method comprises transmitting a screen change signal from a presenter system, the screen change signal indicating a change in presentation material. One or more synchronization signals are received at the presenter system, the one or more synchronization signals indicating current viewing status of one or more participant systems. The current viewing status of the one or more participant systems is updated based on the one or more synchronization signals.

The present application claims the benefit of and priority to U.S. Provisional Patent Application No. 61/045,543 entitled “Sync Indicator for Desktop Sharing and Application Sharing” filed on Apr. 16, 2008, and is hereby, incorporated by reference.

### FIELD

The present invention relates generally to computer systems and more particularly to synchronization indicator enabled sharing.

### BACKGROUND

Desktop sharing and application sharing are frequently used functionalities in online meetings. Because of the complexity of network environments, each participant of an online meeting may have different network connection speeds. The presenter in an online meeting commonly experiences difficulty in confirming whether or not the screen content that other participants are viewing is synchronized with what he/she is viewing or presenting. Often times, the presenter has to confirm with other participants, using voice or chat, whether all participants are synchronized with the material being presented. The latency associated with the manual confirmation and synchronization negatively impacts the effectiveness of online presentations.

### SUMMARY

A method and system for synchronization indicator enabled online meetings are disclosed. According to one embodiment, a computer implemented method comprises transmitting a screen change signal from a presenter system, the screen change signal indicating a change in presentation material. One or more synchronization signals are received at the presenter system, the one or more synchronization signals indicating current viewing status of one or more participant systems. The current viewing status of the one or more participant systems is updated based on the one or more synchronization signals.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A is a system level diagram of an exemplary synchronization indicator enabled sharing system, according to one embodiment.

FIG. 1B is a block diagram of an exemplary synchronization signal within a synchronization indicator enabled sharing system, according to one embodiment.

FIG. 2 is an exemplary interface for a meeting presenter within a synchronization indicator enabled sharing system, according to one embodiment.

FIG. 3 is an exemplary interface for a meeting attendee within a synchronization indicator enabled sharing system, according to one embodiment.

FIG. 4 is a flow diagram for a timestamp transmission process between systems and a communication server within a synchronization indicator enabled sharing system, according to one embodiment.

FIG. 5 is a flow diagram for establishing a relationship between a user system and a provider within a synchronization indicator enabled sharing system, according to one embodiment.

FIG. 6 is a flow diagram for a communication process within a synchronization indicator enabled sharing system, according to one embodiment.

FIG. 7 illustrates an exemplary computer architecture for use with the present system, according to one embodiment.

### DETAILED DESCRIPTION

A method and system for synchronization indicator enabled online meetings are disclosed. According to one embodiment, a computer implemented method comprises transmitting a screen change signal from a presenter system, the screen change signal indicating a change in presentation material. One or more synchronization signals are received at the presenter system, the one or more synchronization signals indicating current viewing status of one or more participant systems. The current viewing status of the one or more participant systems is updated based on the one or more synchronization signals.

A synchronization indicator for desktop sharing and application sharing can be used in online collaboration systems to indicate whether or not all participants are synchronized with the meeting's presenter who is sharing a desktop or application. To be more specific, a synchronization indicator indicates whether or not screen changes on the presenter's system are synchronized with the participants' screens. Screen changes include a computer mouse click, text input, page scrolling, and all other events that change the content of the current computer screen. Once participants are synchronized, the synchronization indicator signal can be sent to and displayed on the meeting software user interface and/or to hardware equipment (e.g. an indicator on handheld equipment).

A synchronization indicator for online sharing allows a presenter to see the synchronization status of all participants in real time, and in some embodiments the participants see the synchronization status of all participants as well. The presenter can adjust his/her speech and/or action speed based on the real time synchronization status information. According to one embodiment, a synchronization indicator notifies a presenter immediately after all participants have seen the latest displayed material shared by the presenter. As a result, the presenter can decide when to begin discussing material or move on.

A synchronization indicator can be used in application and desktop sharing sessions in all kinds of network meeting systems, including but not limited to software meeting systems, hardware meeting equipment, and video conference systems. A synchronization indicator can be implemented on all network architectures and topologies.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

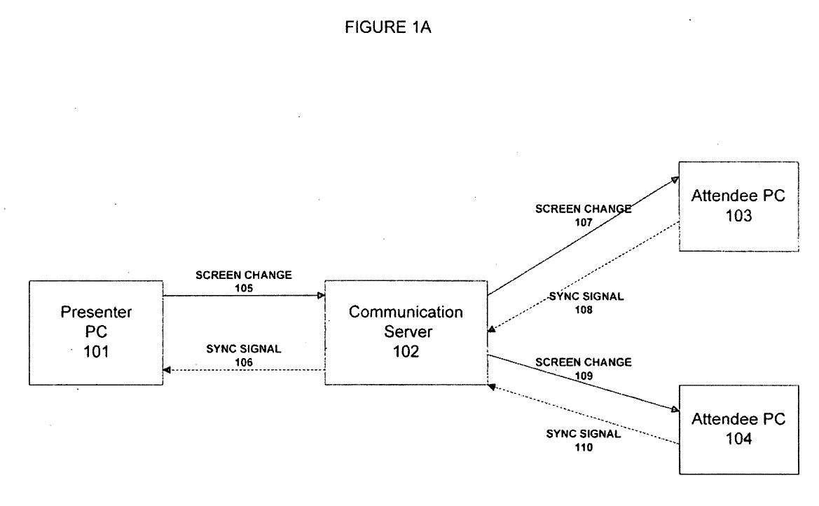

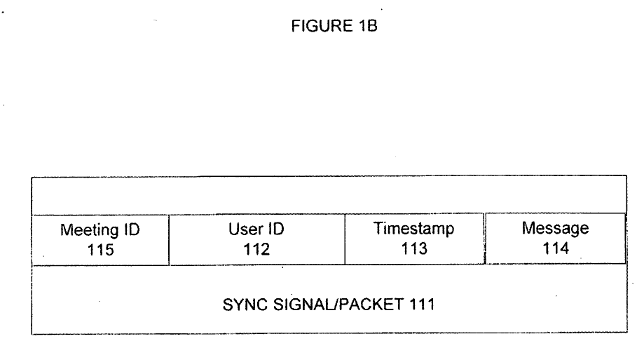

FIG. 1A is a system level diagram of an exemplary synchronization indicator enabled sharing system, according to one embodiment. A presenter PC 101, in control of an online meeting with attendee PCs 103 and 104, changes material presented on the shared meeting screen. The screen change is indicated as a screen change signal 105, the screen change signal containing a timestamp, to a communication server 102. The communication server transmits screen change signals 107 and 109 to the attendee PCs 103 and 104, respectively. The attendee PCs 103 and 104 transmit synchronization signals 108 and 110, respectively, to the communication server 102. The synchronization signals (108 and 110), as will be explained in FIG. 1B, contain timestamps. The communication server 102 gathers the synchronization signals (108 and 110) and transmits a synchronization signal 106 to the presenter PC 101 so that the presenter can know whether the attendees are viewing the most up to date material being presented and slow down if necessary.

FIG. 1B is a block diagram of an exemplary synchronization signal within a synchronization indicator enabled sharing system, according to one embodiment. A synchronization signal or packet 111 contains a meeting ID 114, a system ID 112 to identify which participant is associated with the signal, a timestamp 113, along with a message 114. The message can contain any type of notification, one example is the page a user is viewing.

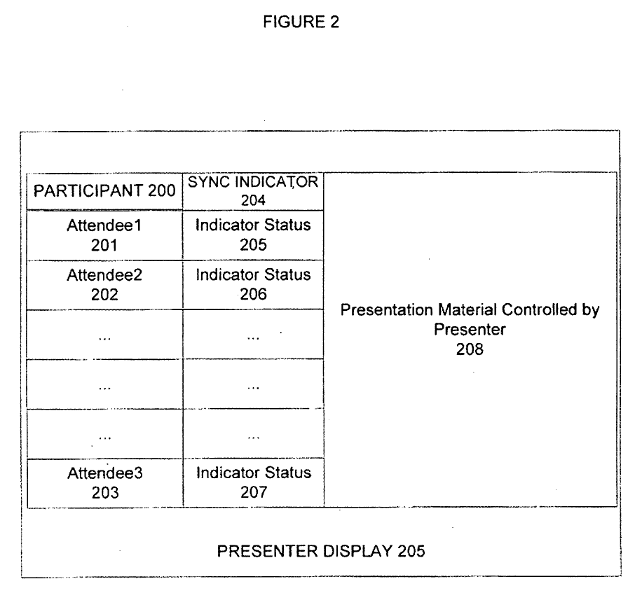

FIG. 2 is an exemplary interface for a meeting presenter within a synchronization indicator enabled sharing system, according to one embodiment. A presenter display 205 contains information relating to material being presented, participants, and synchronization updates. For example, presentation material controlled by the presenter 208 can be positioned at the top of the screen, with participant information below. A list of participants 200 is accompanied by synchronization indicators 204. An attendee1 201 is associated with an indicator status 205. An attendee2 202 is associated with an indicator status 206. An attendee3 203 is associated with an indicator status 207. Each indicator status (205, 206, 207) can be the same or different at any one time, and can vary based upon any level of latency. For example, an indicator status may be a green dot indicating the participant is experiencing no latency or has recovered from any latency and is viewing the presently displayed material. An indicator status may be a red dot indicated the participant is experiencing a significant amount of latency and is far behind in viewing the displayed material. An indicator status may be a yellow dot indicating the participant is experiencing mild to moderate latency and is only one or two pages behind the presently displayed material. Other embodiments allow for configuration of indicator status displays and the defining of tiered latency. In another embodiment there are only two status indicator displays, corresponding to a “yes” or “no” system where the status is “yes” if a participant is synchronized with the displayed presentation materials and “no” otherwise.

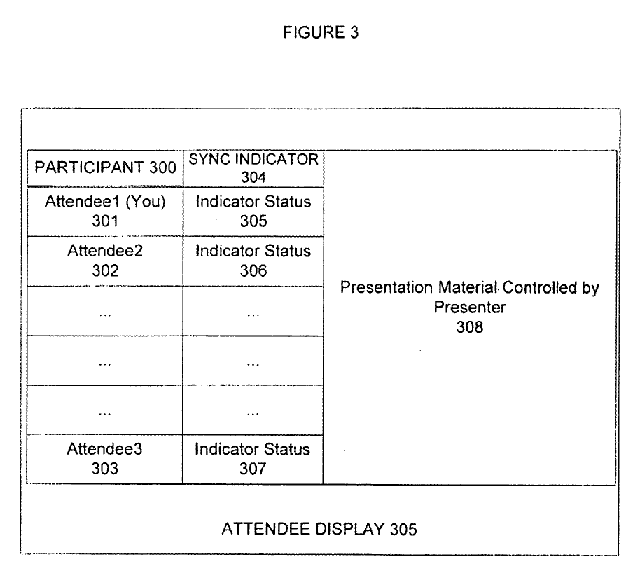

FIG. 3 is an exemplary interface for a meeting attendee within a synchronization indicator enabled sharing system, according to one embodiment. According to one embodiment, meeting attendees may view the synchronization status of all meeting attendees. An attendee display 305 contains information relating to material being presented, participants, and synchronization updates. For example, presentation material controlled by the presenter 308 can be positioned at the top of the screen, with participant information below.

A list of participants 300 is accompanied by synchronization indicators 304. An attendees 301, who can be the attendee viewing the current display, is associated with an indicator status 305. An attendee2 302 is associated with an indicator status 306. An attendee3 303 is associated with an indicator status 307. Each indicator status (305, 306, 307) can be the same or different at any one time, and can vary based upon any level of latency. For example, an indicator status may be a green dot indicating the participant is experiencing no latency or has recovered from any latency and is viewing the presently displayed material. An indicator status may be a red dot indicating the participant is experiencing a significant amount of latency and is far behind in viewing the displayed material. An indicator status may be a yellow dot indicating the participant is experiencing mild to moderate latency and is only one or two pages behind the presently displayed material. Other embodiments allow for configuration of indicator status displays and the defining of tiered latency. In another embodiment there are only two status indicator displays, corresponding to a “yes” or “no” system where the status is “yes” if a participant is synchronized with the displayed presentation materials and “no” otherwise.

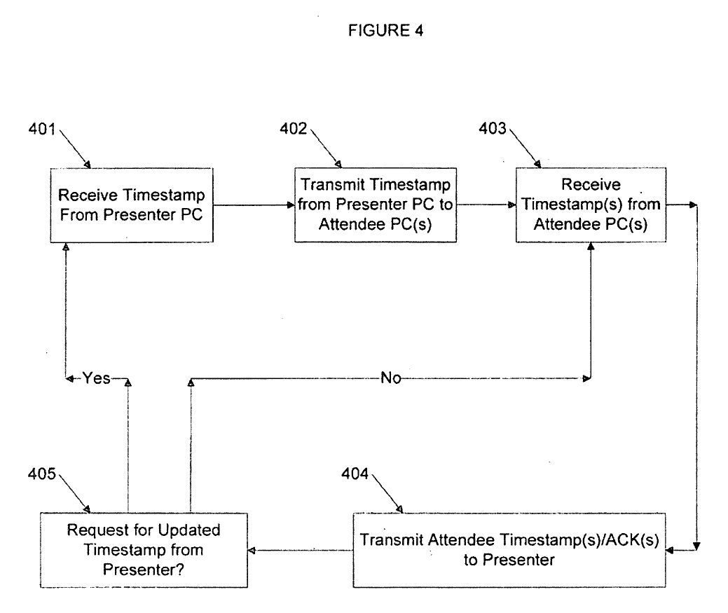

FIG. 4 is a flow diagram for a timestamp transmission process between systems and a communication server within a synchronization indicator enabled sharing system, according to one embodiment. A timestamp is received from a presenter PC 401, in the preferred embodiment this is received by a communication server. The communication server transmits the timestamp it has received from the presenter PC to the attendee PCs 402. The communication server receives a timestamp from each attendee PC 403 and transmits the attendee timestamps (or ACKs) immediately to the presenter PC 405 so that attendee synchronization status can be updated in real-time. A test 406 determines whether the communication server should return to 403 to continue receiving (403) and transmitting (404) timestamps from the attendee PCs to the presenter. Otherwise the test at step 405 results in the communication server returning to 401 to receive an updated timestamp from the presenter PC and continue through the flow from there. According to another embodiment, the timestamps can be received and transmitted by a system other than a communication server. According to embodiments, the test 406 relies upon input from a presenter holding a remote control which is utilized to control presented material displayed to attendees. A presenter holding a remote can request an updated synchronization status by pressing a button on the remote, thereby transmitting an updated timestamp and request to the communication server. The hardware equipment can also be configured to automatically notify the meeting presenter if all participants are synchronized. According to other embodiments the test at step 406 relies upon a specified duration after which an updated timestamp is automatically requested.

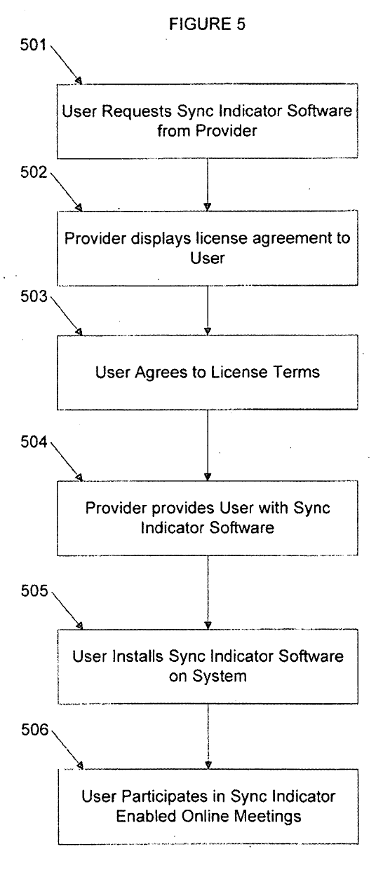

FIG. 5 is a flow diagram for establishing a relationship between a user system and a provider within a synchronization indicator enabled sharing system, according to one embodiment. A user requests synchronization indicator software from a provider 501. The provider provides (through pop-up display or email or other form of communication) a license agreement to the user 502, and the user agrees to the license terms 503. The provider provides (through any form of communication) the user with synchronization indicator software 504 and the user installs the synchronization indicator software onto their system 505. After successful installation the user can participate 506 in synchronization indicator enabled online meetings or other sharing situations.

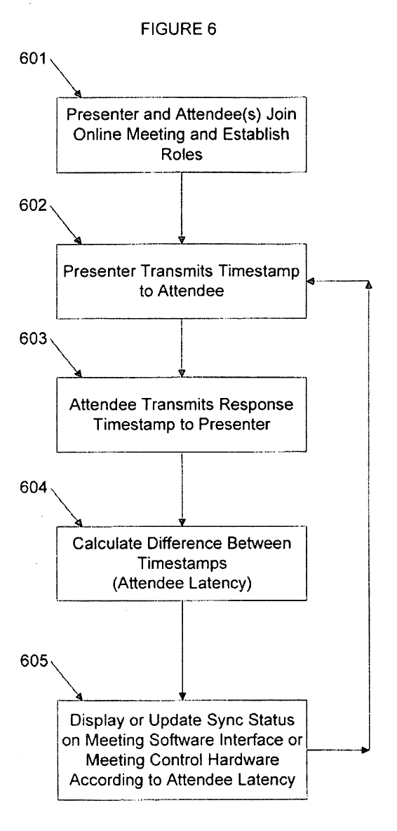

FIG. 6 is a flow diagram for a communication process within a synchronization indicator enabled sharing system, according to one embodiment. A presenter and one or more attendees join an online meeting and establish roles 601. According to one embodiment, all users are designated as attendees upon initially joining the meeting. Roles are then established and an attendee is designated as the presenter. According to another embodiment the roles are established immediately upon users joining the online meeting. A timestamp is transmitted from the presenter to the attendee 602, in one embodiment this is done through a communication server. The attendee transmits a response timestamp to the presenter 603, in the same embodiment this is done through a communication server. Synchronization indicator software calculates the difference between the timestamps to determine attendee latency 604, and displays or updates synchronization status of attendees (using the calculated attendee latency) on a meeting software interface or meeting control hardware 605. The flow then continues by returning to 602 and loops for the duration of the online meeting.

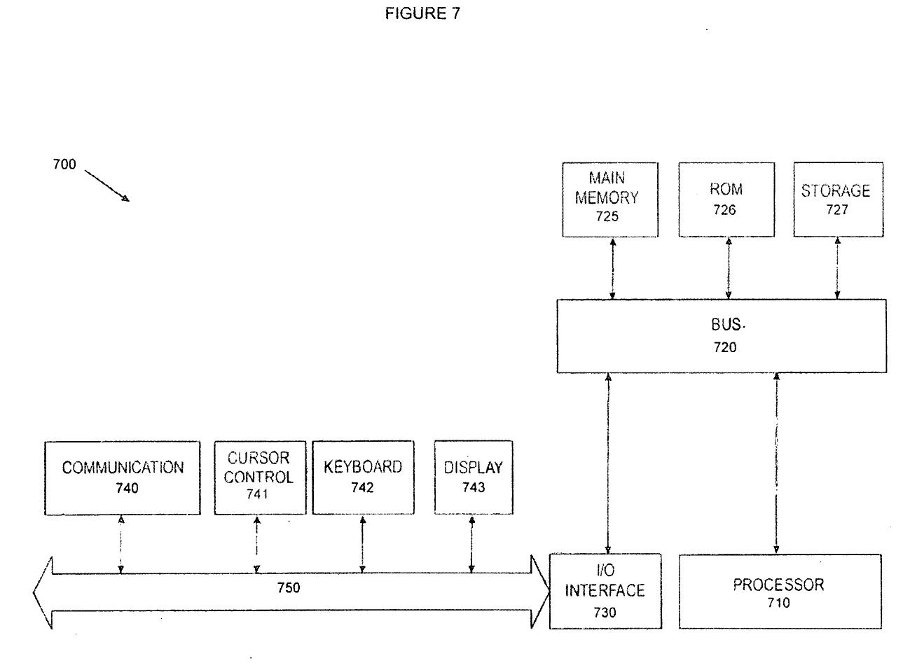

FIG. 7 illustrates an exemplary computer architecture for use with the present system, according to one embodiment. One embodiment of architecture 700 comprises a system bus 720 for communicating information, and a processor 710 coupled to bus 720 for processing information. Architecture 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Architecture 700 also may include a read only memory (ROM) and/or other static storage device 726 coupled to bus 720 for storing static information and instructions used by processor 710.

A data storage device 727 such as a magnetic disk or optical disc and its corresponding drive may also be coupled to computer system 700 for storing information and instructions. Architecture 700 can also be coupled to a second I/O bus 750 via an I/O interface 730. A plurality of I/O devices may be coupled to I/O bus 750, including a display device 743, an input device (e.g., an alphanumeric input device 742 and/or a cursor control device 741).

The communication device 740 allows for access to other computers (servers or clients) via a network. The communication device 740 may comprise one or more modems, network interface cards, wireless network interfaces or other well known interface devices, such as those used for coupling to Ethernet, token ring, or other types of networks.

The system and method disclosed have been described, as an example, as being implemented in an online meeting environment. However, the present system and method can be implemented in any sharing environment with similar properties.

A method and system for synchronization indicator enabled sharing are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer-implemented method, comprising:
transmitting a screen change signal from a presenter system, the screen change signal indicating a change in presentation material;
receiving one or more synchronization signals at the presenter system, the one or more synchronization signals indicating current viewing status of one or more participant systems; and
updating the current viewing status of the one or more participant systems based on the one or more synchronization signals.

2. The computer-implemented method of claim 1, wherein a communication server transmits the screen change signal to the one or more participant systems.

3. The computer-implemented method of claim 1, wherein a communication server transmits the synchronization signals from the one or more participant systems to the presenter system.

4. The computer-implemented method of claim 1, wherein a screen change signal comprises:
a meeting identifier;
a user identifier;
a timestamp; and
a message.

5. The computer-implemented method of claim 1, wherein a synchronization signal comprises:
a meeting identifier;
a user identifier;
a timestamp; and
a message.

6. The computer-implemented method of claim 1, wherein a screen change signal is generated in response to screen change input.

7. The computer-implemented method of claim 6, wherein screen change input comprises one or more of: a mouse click, keyboard input, or page scrolling.

8. The computer-implemented method of claim 1, wherein the current viewing status of the one or more participant systems is displayed on an interface on the presenter system.

9. A system, comprising:
one or more user systems having synchronization indicator software installed thereon, wherein one of the one or more user systems is designated as a presenter system and at least one of the one or more user systems is designated as a participant system; and
a server system having synchronization indicator software installed thereon, wherein the server system passes signals between the one or more user systems.

10. The system of claim 9, further comprising the server system performing the steps of:
receiving a screen change signal from the presenter system;
transmitting the screen change signal to one or more participant systems;
receiving synchronization status signals from the one or more participant systems; and
transmitting the synchronization status signals to the presenter system.

11. The system of claim 10, wherein a screen change signal comprises:
a meeting identifier;
a user identifier;
a timestamp; and
a message.

12. The system of claim 10, wherein a synchronization signal comprises:
a meeting identifier;
a user identifier;
a timestamp; and
a message.

13. A computer-readable medium having stored thereon a plurality of instructions, said plurality of instructions when executed by a computer, cause said computer to perform:
transmitting a screen change signal from a presenter system, the screen change signal indicating a change in presentation material;
receiving one or more synchronization signals at the presenter system, the one or more synchronization signals indicating current viewing status of one or more participant systems; and
updating the current viewing status of the one or more participant systems based on the one or more synchronization signals.

14. The computer-readable medium of claim 13, wherein a screen change signal comprises:
a meeting identifier;
a user identifier;
a timestamp; and
a message.

15. The computer-readable medium of claim 13, wherein a synchronization signal comprises:
a meeting identifier;
a user identifier;
a timestamp; and
a message.

16. The computer-readable medium of claim 13, wherein a screen change signal is generated in response to screen change input.

17. The computer-readable medium of claim 16, wherein screen change input comprises one or more of: a mouse click, keyboard input, or page scrolling.
